(19) United States
(12) Patent Application Publication
(10) Pub. No.: US 2007/0100894 A1
(43) Pub. Date: May 3, 2007

(54) Apparatus and method for encoding data change rates in textual programs

(75) Inventors: Keijo J. Manninen, Varkaus (FI); Jethro F. Steinman, Havertown, PA (US)

Correspondence Address: HONEYWELL INTERNATIONAL INC., 101 COLUMBIA ROAD, P O BOX 2245, MORRISTOWN, NJ, 07962-2245, US

(73) Assignee: Honeywell International Inc., Morristown, NJ (US)

(21) Appl. No.: 11/263,454

(22) Filed: Oct. 31, 2005

(51) Int. Cl. G06F 17/30

(52) U.S. Cl. 707/200

(57) ABSTRACT

An apparatus includes at least one memory capable of storing values of a plurality of data items. The data items are categorized into a plurality of categories by one or more programs that define the data items. The apparatus also includes at least one processor capable of executing the one or more programs that define the data items. The at least one processor is also capable of transferring the values of the data items to a second apparatus. The value of each data item is transferred to the second apparatus at a frequency associated with the category of the data item. The plurality of categories may be associated with a plurality of attributes (such as .NET attributes). Each data item is associated with one of the attributes to thereby identify the category associated with the data item.

### CROSS-REFERENCE TO RELATED APPLICATIONS

This application is related to the following U.S. Patent Applications:

Ser. No. 11/175,848 entitled “DETERMINISTIC RUNTIME EXECUTION ENVIRONMENT AND METHOD” filed on Jul. 6, 2005; and

Ser. No. 11/175,703 entitled “APPARATUS AND METHOD FOR DETERMINISTIC GARBAGE COLLECTION OF A HEAP MEMORY” filed on Jul. 6, 2005;

both of which are hereby incorporated by reference.

### TECHNICAL FIELD

This disclosure relates generally to computing systems and more specifically to an apparatus and method for encoding data change rates in textual programs.

### BACKGROUND

Processing facilities are typically managed using process control systems. Example processing facilities include manufacturing plants, chemical plants, crude oil refineries, and ore processing plants. Motors, catalytic crackers, valves, and other industrial equipment typically perform actions needed to process materials in the processing facilities. Among other functions, the process control systems often manage the use of the industrial equipment in the processing facilities.

In conventional process control systems, various controllers are often used to control the operation of the industrial equipment in the processing facilities. The controllers could, for example, monitor the operation of the industrial equipment, provide control signals to the industrial equipment, and generate alarms when malfunctions are detected.

To provide redundancy in conventional process control systems, multiple controllers are often capable of controlling the same industrial equipment. This redundancy typically requires that a primary controller transfer information to a secondary or backup controller, such as the current status of control operations involving the industrial equipment. This information transfer is usually needed for the secondary controller to take over if the primary controller fails.

### SUMMARY

This disclosure provides an apparatus and method for encoding data change rates in textual programs.

In a first embodiment, an apparatus includes at least one memory capable of storing values of a plurality of data items. The data items are categorized into a plurality of categories by one or more programs that define the data items. The apparatus also includes at least one processor capable of executing the one or more programs that define the data items. The at least one processor is also capable of transferring the values of the data items to a second apparatus. The value of each data item is transferred to the second apparatus at a frequency associated with the category of the data item.

In particular embodiments, the plurality of categories is associated with a plurality of attributes (such as .NET attributes). Each data item is associated with one of the attributes to thereby identify the category associated with the data item.

In a second embodiment, a method includes storing values of a plurality of data items at a device during execution of one or more programs that define the data items. The data items are categorized into a plurality of categories by the one or more programs that define the data items. The method also includes periodically transferring the values of the data items to a backup device. The value of each data item is transferred to the backup device at a frequency associated with the category of the data item.

In a third embodiment, a computer program is embodied on a computer readable medium and is operable to be executed by a processor. The computer program includes computer readable program code for executing one or more programs that define a plurality of data items. The data items are categorized into a plurality of categories by the one or more programs that define the data items. The computer program also includes computer readable program code for periodically transferring values of the data items to a backup device. The value of each data item is transferred to the backup device at a frequency associated with the category of the data item.

Other technical features may be readily apparent to one skilled in the art from the following figures, descriptions, and claims.

### BRIEF DESCRIPTION OF THE DRAWINGS

For a more complete understanding of this disclosure, reference is now made to the following description, taken in conjunction with the accompanying drawings, in which:

FIG. 1 illustrates an example process control system according to one embodiment of this disclosure;

FIG. 2 illustrates an example execution environment according to one embodiment of this disclosure;

FIG. 3 illustrates an example data change rate encoding mechanism according to one embodiment of this disclosure;

FIG. 4 illustrates an example timing of data transfers between redundant controllers according to one embodiment of this disclosure; and

FIG. 5 illustrates an example method for encoding data change rates in textual programs according to one embodiment of this disclosure.

### DETAILED DESCRIPTION

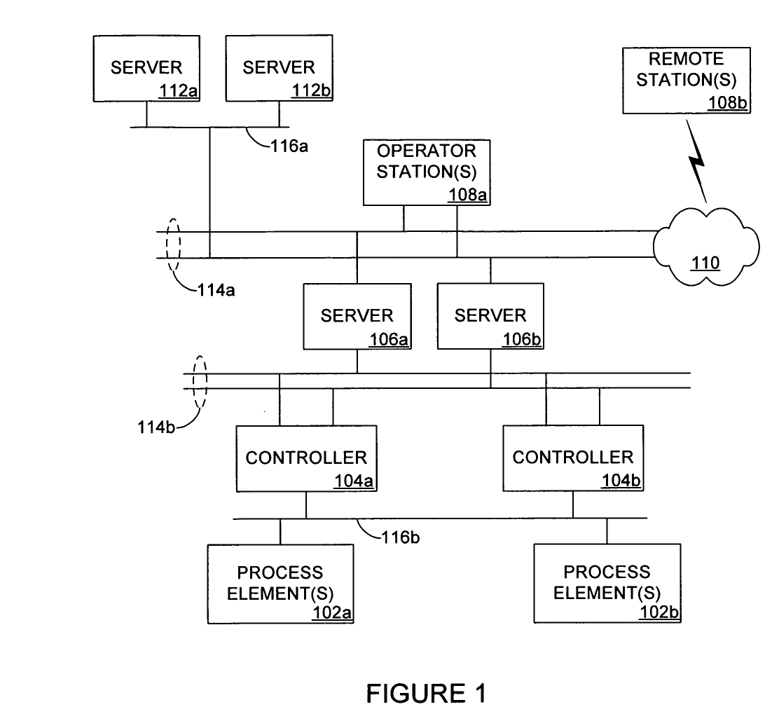

FIG. 1 illustrates an example process control system 100 according to one embodiment of this disclosure. The embodiment of the process control system 100 shown in FIG. 1 is for illustration only. Other embodiments of the process control system 100 may be used without departing from the scope of this disclosure.

In this example embodiment, the process control system 100 includes one or more process elements 102a-102b. The process elements 102a-102b represent components in a process or production system that may perform any of a wide variety of functions. For example, the process elements 102a-102b could represent motors, catalytic crackers, valves, and other industrial equipment in a production environment. The process elements 102a-102b could represent any other or additional components in any suitable process or production system. Each of the process elements 102a-102b includes any hardware, software, firmware, or combination thereof for performing one or more functions in a process or production system.

Two controllers 104a-104b are coupled to the process elements 102a-102b. The controllers 104a-104b control the operation of the process elements 102a-102b. For example, the controllers 104a-104b could be capable of providing control signals to the process elements 102a-102b periodically. As a particular example, if a process element represents a motor, the controllers 104a-104b could provide control information to the motor once every millisecond. Each of the controllers 104a-104b includes any hardware, software, firmware, or combination thereof for controlling one or more of the process elements 102a-102b. The controllers 104a-104b could, for example, represent C300 controllers. As another example, the controllers 104a-104b could include processors of the POWERPC processor family running the GREEN HILLS INTEGRITY operating system or processors of the X86 processor family running a MICROSOFT WINDOWS operating system.

Two servers 106a-106b are coupled to the controllers 104a-104b. The servers 106a-106b perform various functions to support the operation and control of the controllers 104a-104b and the process elements 102a-102b. For example, the servers 106a-106b could log information collected or generated by the controllers 104a-104b, such as status information related to the operation of the process elements 102a-102b. The servers 106a-106b could also execute applications that control the operation of the controllers 104a-104b, thereby controlling the operation of the process elements 102a-102b. In addition, the servers 106a-106b could provide secure access to the controllers 104a-104b. Each of the servers 106a-106b includes any hardware, software, firmware, or combination thereof for providing access to or control of the controllers 104a-104b. The servers 106a-106b could, for example, represent personal computers (such as desktop computers) executing WINDOWS 2000 from MICROSOFT CORPORATION. As another example, the servers 106a-106b could include processors of the POWERPC processor family running the GREEN HILLS INTEGRITY operating system or processors of the X86 processor family running a MICROSOFT WINDOWS operating system.

One or more operator stations 108a-108b are coupled to the servers 106a-106b. The operator stations 108a-108b represent computing or communication devices providing user access to the servers 106a-106b, which could then provide user access to the controllers 104a-104b and the process elements 102a-102b. For example, the operator stations 108a-108b could allow users to review the operational history of the process elements 102a-102b using information collected by the controllers 104a-104b and servers 106a-106b. The operator stations 108a-108b could also allow the users to adjust the operation of the process elements 102a-102b, controllers 104a-104b, or servers 106a-106b. Each of the operator stations 108a-108b includes any hardware, software, firmware, or combination thereof for supporting user access and control of the system 100. The operator stations 108a-108b could, for example, represent personal computers executing WINDOWS 95, WINDOWS 2000, or WINDOWS NT from MICROSOFT CORPORATION.

In this example, at least one of the operator stations 108b is a remote station. The remote station is coupled to the servers 106a-106b through a network 110. The network 110 facilitates communication between various components in the system 100. For example, the network 110 may communicate Internet Protocol (IP) packets, frame relay frames, Asynchronous Transfer Mode (ATM) cells, or other suitable information between network addresses. The network 110 may include one or more local area networks (LANs), metropolitan area networks (MANs), wide area networks (WANs), all or a portion of a global network such as the Internet, or any other communication system or systems at one or more locations.

In this example, the system 100 includes two additional servers 112a-112b. The servers 112a-112b execute various applications to control the overall operation of the system 100. For example, the system 100 could be used in a processing or production plant or other facility, and the servers 112a-112b could execute applications used to control the plant or other facility. As particular examples, the servers 112a-112b could execute applications such as enterprise resource planning (ERP), manufacturing execution system (MES), or any other or additional plant or process control applications. Each of the servers 112a-112b includes any hardware, software, firmware, or combination thereof for controlling the overall operation of the system 100.

As shown in FIG. 1, the system 100 includes various redundant networks 114a-114b and single networks 116a-116b that support communication between components in the system 100. Each of these networks 114a-114b, 116a-116b represents any suitable network or combination of networks facilitating communication between components in the system 100. The networks 114a-114b, 116a-116b could, for example, represent Ethernet networks.

In one aspect of operation, the controllers 104a-104b represent redundant controllers used to control the process elements 102a-102b. For example, the controller 104a could represent the primary controller for both process elements 102a-102b, and the controller 104b could represent a secondary or backup controller for both process elements 102a-102b. As another example, each of the controllers 104a-104b could represent the primary controller for one of the process elements 102a-102b and the secondary controller for another of the process elements 102a-102b.

In order to support redundancy between the controllers 104a-104b, the controllers 104a-104b routinely transfer information to each other, such as information identifying current control operations involving the process elements 102a-102b. For example, the primary controller of a process element typically transmits data to the secondary controller of the process element. This allows the primary controller to keep the secondary controller relatively up-to-date regarding the control of the process element. As a particular example, the primary controller 104a of process element 102a could routinely transmit data about the process element 102a to the secondary controller 104b.

To support the transfer of information between redundant controllers 104a-104b, the controllers 104a-104b support a mechanism where data items may be categorized based on how often the data items are expected to change. For example, data items may be categorized into a “frequently changing” category and a “rarely changing” category. The category for a particular data item may be specified in a textual program (such as a C# or Visual Basic .Net program) defining that data item. The textual programs are used to implement control algorithms in the controllers 104a-104b, where the control algorithms control one or more process elements. In particular embodiments, the categorization is done by control engineers or other personnel who write algorithm blocks or other units of programming code. In this way, the categorization of data is encoded into the textual programs themselves.

Data values are then sent from a primary controller to a secondary controller at a frequency based on the categorization of the data items. For example, values of data items categorized as “rarely changing” may be transmitted from a primary controller to a secondary controller only upon changes to the data values or at relatively longer intervals. Values of data items categorized as “frequently changing” may be transmitted from a primary controller to a secondary controller more frequently, such as after execution of each algorithm block and without reference to whether the data values have actually changed.

In some embodiments, the controllers 104a-104b execute, support, or otherwise provide access to an execution environment. The execution environment provides support for various features that managed applications may use during execution. As examples, the execution environment could provide support for mathematical functions, input/output functions, and communication functions. The phrase “managed application” refers to an application executed in the execution environment, where the execution of the application is managed by the execution environment. In some embodiments, all applications executed in the execution environment may represent “managed applications.” Managed applications could include textual or other programs in which categorizations of data items have been encoded.

In particular embodiments, the execution environment used in the controllers 104a-104b to execute the managed applications is deterministic. A deterministic execution environment is an execution environment whose behavior is predictable or that can be precisely specified. The execution environment could be implemented in any suitable manner, such as by using .Net programming based on the Common Language Interface (CLI) specification as ratified by ECMA-335 and support both the Kernel and Compact profiles.

By allowing control engineers or other personnel to categorize data items in textual programs, this mechanism may provide a natural and intuitive method for categorizing the data items. It allows engineers or other personnel to specify how data items are categorized and how often values of the data items are transferred between redundant controllers 104a-104b. It may also be implemented with few or no hardware modifications and could be implemented on a variety of computing platforms. In addition, it may help to reduce or minimize the amount of data transferred between redundant controllers 104a-104b.

While this description has described the use of two categories (“frequently changing” and “rarely changing”), any suitable number of categories could be defined. Also, any suitable criteria could be used to define “frequently” and “rarely” changing. Further, each category may be associated with any suitable frequency of data transfer between redundant controllers 104a-104b, such as an increasing frequency of data transfer as the frequency of expected change increases. Beyond that, the phrase “data item” refers to any piece of data or combination of data pieces, such as integers, floating values, strings, and data structures. In addition, the phrase “textual program” refers to any program or other computer code that is defined by text, where the text is compiled, assembled, or otherwise converted into machine-executable code. Textual programs may include, for example, C# and Visual Basic .Net programs.

Although FIG. 1 illustrates one example of a process control system 100, various changes may be made to FIG. 1. For example, a control system could include any number of process elements, controllers, servers, and operator stations. Also, FIG. 1 illustrates one operational environment in which the categorization of data items for use in controlling the frequency of transfer between redundant devices could be used. The data categorization technique could be used in any other suitable device or system.

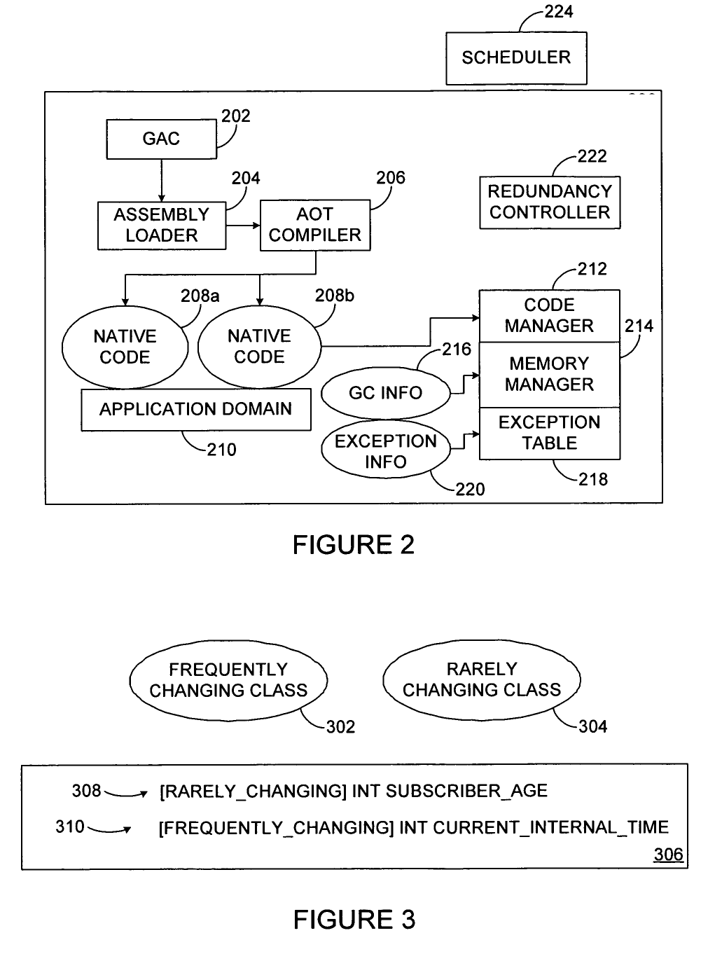

FIG. 2 illustrates an example execution environment 200 according to one embodiment of this disclosure. The embodiment of the execution environment 200 shown in FIG. 2 is for illustration only. Other embodiments of the execution environment could be used without departing from the scope of this disclosure. Also, for ease of explanation, the execution environment 200 is described as being implemented in the controllers 104a-104b of FIG. 1, although the execution environment 200 could be used in any other suitable device or system.

In this example embodiment, the execution environment 200 includes a global assembly cache (GAC) 202. The global assembly cache 202 represents a memory capable of storing different assembly code programs to be executed in the execution environment 200. The assembly code programs could represent the managed applications to be executed in the execution environment 200. As an example, the global assembly cache 202 could store an assembly code program capable of controlling one or more of the process elements 102a-102b of FIG. 1. As a particular example, the global assembly cache 202 could store assembly code versions of textual programs with encoded categorizations of data items. The global assembly cache 202 could store multiple assembly code programs and/or different versions of the same assembly code program. The global assembly cache 202 represents any suitable storage and retrieval device or devices.

An assembly loader 204 loads assembly code into the execution environment 200 for execution. For example, the assembly loader 204 may retrieve new assembly code downloaded by a user into the global assembly cache 202. The assembly loader 204 may then load the identified assembly code into a compiler for compilation and use in the execution environment 200. The assembly loader 204 includes any hardware, software, firmware, or combination thereof for loading assembly code for compilation. The assembly loader 204 could, for example, represent a software thread executed in the background of the execution environment 200.

An ahead-of-time (AOT) compiler 206 compiles the assembly code loaded by the assembly loader 204. The AOT compiler 206 represents a load-time compiler that compiles assembly code when the assembly code is loaded. For example, the AOT compiler 206 may convert assembly code from an intermediate language to native executable code capable of being executed in the execution environment 200. Also, the AOT compiler 206 could insert instructions into the native executable code to ensure proper execution of the code in the execution environment 200. The AOT compiler 206 includes any hardware, software, firmware, or combination thereof for compiling assembly code. The AOT compiler 206 could, for example, represent a software thread executed in the background of the execution environment 200.

The AOT compiler 206 produces native executable code, such as native executable codes 208a-208b. The native executable codes 208a-208b represent executable code capable of being executed in the execution environment 200. The native executable codes 208a-208b could provide any suitable functionality in the execution environment 200, such as providing control of one or more process elements 102a-102b of FIG. 1. The native executable codes 208a-208b could provide any other or additional functionality in the execution environment 200.

One or more application domains 210 represent the domains in which one or more managed applications (such as the applications implemented by the native executable codes 208a-208b) are executed in the execution domain 200. Each application domain 210 represents any suitable domain for executing one or more managed applications. While shown as a single application domain 210 in FIG. 2, multiple application domains 210 could be used.

The assembly codes and native executable codes in the execution environment 200 are managed by a code manager 212. For example, the code manager 212 may control the loading and unloading of assembly code in the execution environment 200. As a particular example, the code manager 212 could cause the assembly loader 204 to load assembly code into the AOT compiler 206, which generates native executable code that is loaded into the application domain 210. The code manager 212 could also unload native executable code from the application domain 210. The code manager 212 includes any hardware, software, firmware, or combination thereof for managing assembly code and/or compiled code used in the execution environment 200. The code manager 212 could, for example, represent a software thread executed in the background of the execution environment 200.

The execution environment 200 also includes a memory manager 214. The memory manager 214 manages the use of a memory. For example, the memory manager 214 could allocate blocks of memory to managed applications being executed in the application domain 210. The memory manager 214 could also use garbage collection information 216 to release blocks of memory that are no longer being used by the managed applications. The garbage collection information 216 could, for example, be generated by a garbage collection process provided by the memory manager 214 and executed in the background of the execution environment 200. In addition, the memory manager 214 could support a defragmentation process for the memory. The defragmentation process could be used to combine unused blocks of memory into larger blocks. The memory manager 214 includes any hardware, software, firmware, or combination thereof for managing a memory. The memory manager 214 could, for example, represent a deterministic memory manager. The memory manager 214 could also represent a software thread executed in the background of the execution environment 200.

The execution environment 200 further includes an exception table 218, which stores exception information 220. The exception information 220 identifies various problems experienced in the execution environment 200. Example problems could include attempting to load assembly code that does not exist in an explicitly specified location or in the global assembly cache 202, an error during compilation of loaded assembly code, or attempting to unload assembly code not previously loaded. An application or process being executed in the execution environment 200 could generate an exception identifying a detected problem. The exception is identified by the exception information 220, which is stored in the exception table 218 for later use (such as during debugging) or for use by the application or process for automatic recovery at runtime.

In addition, the execution environment 200 includes a redundancy controller 222. The redundancy controller 222 supports the transfer of data item values between redundant controllers 104a-104b. For example, the redundancy controller 222 could identify data items that have been categorized in textual programs that define the data items. As a particular example, data items may be categorized by associating the data items with different attributes (such as .Net attributes) in textual programs, where each attribute is associated with a different category. The redundancy controller 222 could detect or identify the relevant attribute associated with each data item to identify how the data item is categorized. Once the categorization of a data item is known, the redundancy controller 222 can ensure that the value of the data item is transferred from one controller to another at the appropriate frequency. The redundancy controller 222 includes any hardware, software, firmware, or combination thereof for supporting the transfer of data between redundant devices at different intervals depending on how the data is categorized in a textual program. The redundancy controller 222 could, for example, represent a software thread executed in the background of the execution environment 200.

A scheduler 224 is used to schedule execution of the managed applications. The scheduler 224 may also be used to schedule execution of housekeeping tasks in the execution environment 200. The housekeeping tasks include, among other things, memory management, assembly loading and unloading, and assembly compilation. For example, the scheduler 224 could support time slicing to allow multiple threads to be executed, where the threads represent the housekeeping tasks and the managed applications. The scheduler 224 includes any hardware, software, firmware, or combination thereof for scheduling the execution of applications and other tasks.

In some embodiments, the scheduler 224 and the execution environment 200 cooperate and collaborate to ensure that the managed applications and the housekeeping tasks are executed properly. For example, the scheduler 224 may control when and for how long the housekeeping tasks may be executed in the execution environment 200. As a particular example, the scheduler 224 could preempt all threads executing the managed applications and then call the execution environment 200 to execute one or more housekeeping tasks. The scheduler 224 informs the execution environment 200 of the amount of time available to perform the housekeeping tasks. The execution environment 200 guarantees that control is returned to the scheduler 224 on or before the expiration of that amount of time. While the execution environment 200 is performing a housekeeping task, managed applications that read or write data to a heap memory may not interrupt the housekeeping task. Other threads that do not access a heap memory (such as an interrupt service routine or ISR) could be allowed to interrupt a housekeeping task. Averaged over time, the scheduler 224 may provide the execution environment 200 with enough time to perform the housekeeping tasks needed for the managed applications to execute properly. As an example, the managed applications may use up to approximately 80% of the time slices available, while the remaining 20% are used by the housekeeping tasks.

This type of scheduling may impose certain requirements on the managed applications. For example, the managed applications should, over time, allow adequate processing resources to be provided to and used by the housekeeping tasks. Also, a managed application should either come to a “clean point” or use read and write barriers before transferring control to the housekeeping tasks. A “clean point” generally represents a point where a sequence of related instructions being executed for the managed application has been completed, rather than a point that occurs during execution of the sequence of related instructions. As an example, a managed application should complete accessing data in a data structure or file when the transfer of control occurs, rather than being in the middle of reading data or writing data. A read or write barrier is used when the managed application is not at a clean point when the transfer of control occurs. The read or write barrier generally represents a marker or flag used to inform the housekeeping tasks that particular data is currently being used by a managed application. This may prevent the housekeeping tasks from moving the data during defragmentation or discarding the data during garbage collection.

In some embodiments, the various components shown in FIG. 2 operate over a platform/operating system abstraction layer. The platform/operating system abstraction layer logically separates the execution environment 200 from the underlying hardware platform or operating system. In this way, the execution environment 200 may be used with different hardware platforms and operating systems without requiring the execution environment 200 to be specifically designed for a particular hardware platform or operating system.

Although FIG. 2 illustrates one example of an execution environment 200, various changes may be made to FIG. 2. For example, the functional division shown in FIG. 2 is for illustration only. Various components in FIG. 2 could be combined or omitted and additional components could be added according to particular needs.

FIG. 3 illustrates an example data change rate encoding mechanism 300 according to one embodiment of this disclosure. The data change rate encoding mechanism 300 shown in FIG. 3 is for illustration only. Other embodiments of the data change rate encoding mechanism 300 could be used without departing from the scope of this disclosure.

In this example embodiment, the categorization of data items uses the ability to assign attributes to data items. For example, .NET provides a mechanism to define classes, which are instantiated within meta data to create attributes that describe elements of a textual program. In this example, two classes 302-304 are defined. One class 302 creates a “frequently changing” attribute, and the other class 304 creates a “rarely changing” attribute.

Once these attributes are created or supported in the execution environment 200 of the controllers 104a-104b, programs executed in the execution environment 200 may use these attributes to categorize data items. For example, an attribute label or other identifier could be inserted into a textual program before a data item definition, thereby associating that data item with the attribute identified by the attribute identifier.

As shown in FIG. 3, a textual program 306 includes two data item definitions 308-310. The first data item definition 308 defines an integer that represents a person's age, and the second data item definition 310 defines an integer that represents the current internal time of a controller. A person's age typically does not change very often, so the data item definition 308 includes the identifier for the “rarely changing” attribute. The current internal time is constantly changing, so the data item definition 310 includes the identifier for the “frequently changing” attribute. The identifiers for these attributes are located in brackets prior to the definitions of the integers.

Using the attribute identifiers as shown in FIG. 3, the redundancy controller 222 may detect which attribute is associated with a particular data item. The redundancy controller 222 may then ensure that the value of the data item is transmitted to a secondary controller at a frequency associated with the identified attribute.

Although FIG. 3 illustrates one example of a data change rate encoding mechanism 300, various changes may be made to FIG. 3. For example, there could be any number of attributes defined for any number of data item categories. Also, other techniques could be used to associate a particular data item with a particular attribute.

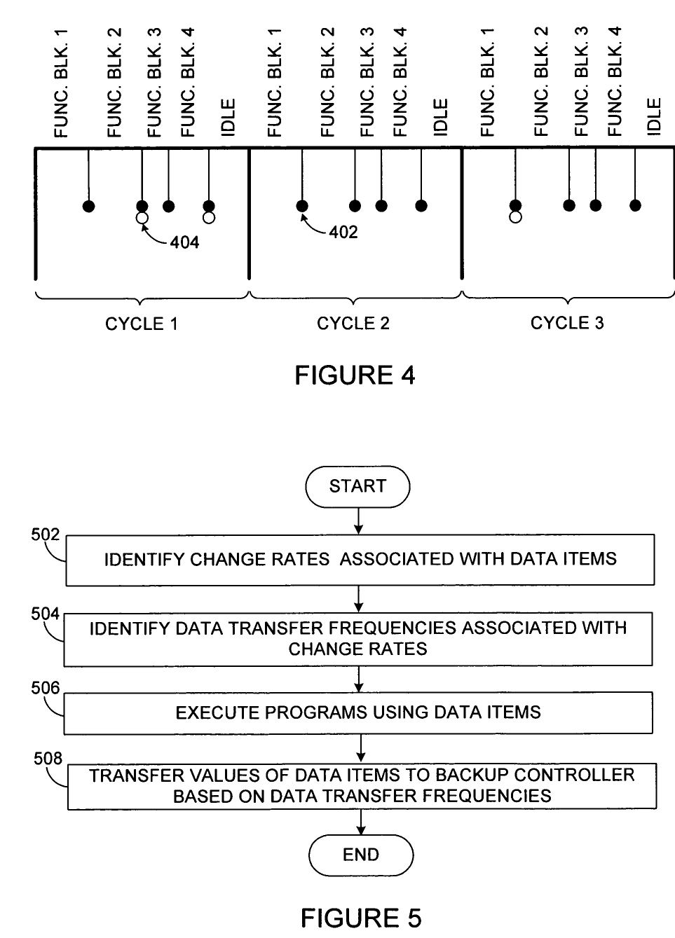

FIG. 4 illustrates an example timing 400 of data transfers between redundant controllers according to one embodiment of this disclosure. The timing 400 shown in FIG. 4 is for illustration only. Other timings of data transfers could be used without departing from the scope of this disclosure.

As shown in FIG. 4, execution in the execution environment 200 is divided into multiple cycles 400, each of which includes multiple time slices. The time slices in each cycle 400 are used by different function blocks (the managed applications, including textual programs that encode categorizations of data items), except for one idle period where housekeeping tasks such as memory management are performed.

In FIG. 4, the circles 402 illustrate when values of data items may be transferred between controllers 104a-104b for frequently changing data items. In this example, frequently changing data is transferred between controllers 104a-104b at the end of each function block time slice (after a function block is executed). For example, the data transmitted at the end of one function block time slice could represent the frequently changing data used by that function block. In some embodiments, the frequently changing data may be transferred between controllers 104a-104b after execution of a function block even if the function block did not change the frequently changing data.

The circles 404 in FIG. 4 illustrate when values of data items may be transferred between controllers 104a-104b for rarely changing data items. In this example, rarely changing data is transferred between controllers 104a-104b only after a function block changes the rarely changing data. For example, the rarely changing data transmitted at the end of one function block time slice could represent the rarely changing data used by the function block that actually changed during the time slice. In some embodiments, the rarely changing data is transferred only at the end of a function block time slice. In other embodiments, the rarely changing data is transferred immediately when the change occurs. In yet other embodiments, rarely changing data is transferred periodically (with or without regard to whether the data has changed), but the frequency is less than the frequency associated with frequently changing data.

Although FIG. 4 illustrates one example timing 400 of data transfers between redundant controllers, various changes may be made to FIG. 4. For example, the transfer of frequently changing data need not occur at the end of each function block time slice. Also, any suitable frequency of data transfer may be used for the different categories of data.

FIG. 5 illustrates an example method 500 for encoding data change rates in textual programs according to one embodiment of this disclosure. For ease of explanation, the method 500 is described with respect to the controller 104a in the process control system 100 of FIG. 1. The method 500 could be used by any other suitable device and in any other suitable system.

The controller 104a identifies change rates associated with multiple data items at step 502. This may include, for example, the controller 104a identifying different attributes (such as “frequently changing” and “rarely changing” attributes) for the multiple data items. The attributes may be associated with the data items where the data items are defined. The attributes may represent different categories of data items (such as “frequently changing” and “rarely changing” categories), where the categories are associated with different actual or expected change rates.

The controller 104a identifies different data transfer frequencies associated with the data items at step 504. This may include, for example, the controller 104a identifying (for each category) a frequency at which the controller 104a transfers values of data items to a secondary controller 104b. As a particular example, this may include the controller 104a determining that “frequently changing” data item values are transferred after execution of a function block that defined those data items. This may also include the controller 104a determining that “rarely changing” data item values are transferred only after those data item values change or at a frequency that is less than a frequency associated with the “frequently changing” data item values.

The controller 104a executes one or more programs that use the data items at step 506. This may include, for example, the controller 104a executing one or multiple function blocks during each of multiple cycles 400. This may also include the controller 104a determining if and when the values of data items classified as “rarely changing” actually change during execution of the function blocks.

The controller 104a transfers values of the data items to the backup or secondary controller 104b based on the identified data transfer frequencies at step 508. This may include, for example, the controller 104a transferring “frequently changing” data item values defined by a function block to the controller 104b at the end of that function block's execution. This may also include the controller 104a transferring “rarely changing” data item values to the controller 104b when those data item values change or at the appropriate frequency.

Although FIG. 5 illustrates one example of a method 500 for encoding data change rates in textual programs, various changes may be made to FIG. 5. For example, while shown as a sequence of serial steps, various steps in FIG. 5 could be performed in parallel or overlap. As a particular example, the performance of steps 506 and 508 could overlap.

In some embodiments, the various functions performed by, within, or in conjunction with the controllers 104a-104b are implemented or supported by a computer program that is formed from computer readable program code and that is embodied in a computer readable medium. The phrase “computer readable program code” includes any type of computer code, including source code, object code, and executable code. The phrase “computer readable medium” includes any type of medium capable of being accessed by a computer, such as read only memory (ROM), random access memory (RAM), a hard disk drive, a compact disc (CD), a digital video disc (DVD), or any other type of memory.

It may be advantageous to set forth definitions of certain words and phrases used throughout this patent document. The term “couple” and its derivatives refer to any direct or indirect communication between two or more elements, whether or not those elements are in physical contact with one another. The term “application” refers to one or more computer programs, sets of instructions, procedures, functions, objects, classes, instances, or related data adapted for implementation in a suitable computer language. The terms “include” and “comprise,” as well as derivatives thereof, mean inclusion without limitation. The term “or” is inclusive, meaning and/or. The phrases “associated with” and “associated therewith,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, or the like. The term “controller” means any device, system, or part thereof that controls at least one operation. A controller may be implemented in hardware, firmware, software, or some combination of at least two of the same. The functionality associated with any particular controller may be centralized or distributed, whether locally or remotely.

While this disclosure has described certain embodiments and generally associated methods, alterations and permutations of these embodiments and methods will be apparent to those skilled in the art. Accordingly, the above description of example embodiments does not define or constrain this disclosure. Other changes, substitutions, and alterations are also possible without departing from the spirit and scope of this disclosure, as defined by the following claims.

What is claimed is:

1. An apparatus, comprising:
at least one memory capable of storing values of a plurality of data items, the data items categorized into a plurality of categories by one or more programs that define the data items; and
at least one processor capable of:
executing the one or more programs that define the data items; and
transferring the values of the data items to a second apparatus, wherein the value of each data item is transferred to the second apparatus at a frequency associated with the category of the data item.

2. The apparatus of claim 1, wherein the plurality of categories are associated with different frequencies of change to the values of the data items in the categories.

3. The apparatus of claim 2, wherein:
the plurality of categories are associated with a plurality of attributes; and
each data item is associated with one of the attributes to thereby identify the category associated with the data item.

4. The apparatus of claim 3, wherein:
each attribute is associated with an attribute identifier;
each data item is defined by a data item definition in the one or more programs; and
the data item definition for each data item is preceded by the attribute identifier for one of the attributes to associate the data item and the attribute.

5. The apparatus of claim 4, wherein:
the one or more programs that define the data items comprise one or more textual programs; and
the at least one processor is capable of executing one or more machine-executable versions of the one or more textual programs.

6. The apparatus of claim 5, wherein:
the one or more textual programs comprise at least one of: a C# program and a Visual Basic .NET program; and
the plurality of attributes comprises a plurality of .NET attributes.

7. The apparatus of claim 2, wherein:
the plurality of categories comprises a first category and a second category; and
the values of the data items in the first category change more frequently than the values of the data items in the second category.

8. The apparatus of claim 7, wherein:
the one or more programs are executed in blocks;
the value of each data item in the first category is transferred to the second apparatus after execution of the block associated with the data item; and
the value of each data item in the second category is transferred to the second apparatus when the value changes or periodically at a longer interval.

9. The apparatus of claim 1, wherein:
the apparatus comprises a controller in a process control system, the controller capable of controlling one or more process elements in the process control system; and
the second apparatus comprises a backup controller capable of controlling the one or more process elements in the process control system.

10. The apparatus of claim 1, wherein the one or more programs are executed in a deterministic execution environment.

11. A method, comprising:
storing values of a plurality of data items at a device during execution of one or more programs that define the data items, the data items categorized into a plurality of categories by the one or more programs that define the data items; and
periodically transferring the values of the data items to a backup device, wherein the value of each data item is transferred to the backup device at a frequency associated with the category of the data item.

12. The method of claim 11, wherein the plurality of categories are associated with different frequencies of change to the values of the data items in the categories.

13. The method of claim 12, wherein the plurality of categories are associated with a plurality of attributes; and
further comprising associating each data item with one of the attributes to thereby identify the category associated with the data item.

14. The method of claim 13, wherein:
each attribute is associated with an attribute identifier;
each data item is defined by a data item definition in the one or more programs; and
the data item definition for each data item is preceded by the attribute identifier for one of the attributes to associate the data item and the attribute.

15. The method of claim 14, wherein the one or more programs that define the data items comprise one or more textual programs.

16. The method of claim 12, wherein:
the plurality of categories comprises a first category and a second category; and
the values of the data items in the first category change more frequently than the values of the data items in the second category.

17. The method of claim 16, wherein:
the one or more programs are executed in blocks;
the value of each data item in the first category is transferred to the backup device after execution of the block associated with the data item; and
the value of each data item in the second category is transferred to the backup device when the value changes or periodically at a longer interval.

18. A computer program embodied on a computer readable medium and operable to be executed by a processor, the computer program comprising computer readable program code for:
executing one or more programs that define a plurality of data items, the data items categorized into a plurality of categories by the one or more programs that define the data items; and
periodically transferring values of the data items to a backup device, wherein the value of each data item is transferred to the backup device at a frequency associated with the category of the data item.

19. The computer program of claim 11, wherein:
the plurality of categories are associated with a plurality of attributes;
each attribute is associated with an attribute identifier;
each data item is defined by a data item definition in the one or more programs; and
the data item definition for each data item is preceded by the attribute identifier for one of the attributes to associate the data item and the attribute.

20. The computer program of claim 19, wherein:
the one or more programs that define the data items comprise one or more textual programs;
the plurality of categories comprises a first category and a second category; and
the values of the data items in the first category change more frequently than the values of the data items in the second category.
